(19) United States
(12) Patent Application Publication
(10) Pub. No.: US 2010/0114822 A1
(43) Pub. Date: May 6, 2010

(54) Method and System for Agent-Assisted Browsing

(76) Inventors: Steven Samuel Pollock, Los Altos, CA (US); Ashok Mitter Khosla, Palo Alto, CA (US)

Correspondence Address: HAHN AND MOODLEY, LLP, 548 Market Street, San Francisco, CA, 94104, US

(21) Appl. No.: 12/264,841

(22) Filed: Nov. 4, 2008

(51) Int. Cl. G06F 15/16; G06F 17/00; G06F 7/00

(52) U.S. Cl. 707/623; 709/217; 715/205; 707/E17.001

(57) ABSTRACT

In one embodiment, the invention provides a method for accessing data remotely by using a telecommunications network through an internet capable client device. The method comprises providing to a live agent, a desktop control with relevant tools to facilitate an interaction with a caller and maintaining a voice call via a telecommunications network between said live agent and said caller. The method further comprises identifying an endpoint device of the caller and displaying synchronized information relevant to what the caller said during the voice call simultaneously on the desktop control and the endpoint device, the information being configured for display on the endpoint device.

### FIELD

Embodiments of the invention relate generally to endpoint devices such as mobile devices. More particularly, embodiments of the invention relate to the use of said endpoint devices to access data and/or applications located remotely.

### BACKGROUND

A mobile device (also known as a “handheld device”, “user device”, “client device”, or simply “handheld”) is a portable computing device that has a display screen, and one or more input devices such as a miniature keyboard, touch screen, stylus, etc. Examples of mobile device include mobile phones, and Personal Digital Assistants (PDAs). Being portable, mobile devices are highly compact. Thus, the display screens and keyboards of mobile devices tend to be relatively small, making it difficult to input data and view information on such devices.

Mobile devices are commonly provisioned with mobile browsers to allow for Internet access, an activity that has come to be known as “web surfing” or “surfing”. With the rollout of high speed networks such as the so-called 3G network, connection speeds have improved, thus making for a more satisfying user experience while surfing. However, given the aforementioned difficulty in inputting and viewing information, user experience while surfing may still be rather poor.

### SUMMARY

In one aspect, the present invention provides a method, comprising providing to a live agent, a desktop control with relevant tools to facilitate an interaction with a caller and maintaining a voice call via a telecommunications network between said live agent and said caller. The interaction is bi-directional and includes updating the caller and the agent with information in real-time. The method further comprises identifying an endpoint device of the caller and displaying synchronized information relevant to what the caller said during the voice call simultaneously on the desktop control and the endpoint device, the information being configured for display on the endpoint device.

In another aspect, the present invention provides a computer-readable medium having stored thereon a sequence of instructions, which when executed by a computer cause the computer to perform a method comprising retrieving by the computer relevant information to a live agent in a display while maintaining a voice call between a live agent and a caller and identifying an endpoint device of the caller. The method further comprises displaying synchronized information relevant to what the caller said during the voice call simultaneously on the desktop control and the endpoint device, the information being configured for display on the endpoint device.

### BRIEF DESCRIPTION OF THE DRAWINGS

FIG. 1 is a schematic diagram of an example embodiment of a network configuration hosting an agent assisted browsing service within which the invention may be practiced.

FIG. 2 is a schematic diagram of an example scenario in which a caller calls a live agent directly using a telephone number associated with the live agent.

FIG. 3 is a schematic diagram of another example scenario in which “click-to-call” is used by the caller.

FIG. 4 is a flow diagram of a method illustrating a live agent entering customer information into CRM (Customer Relationship Management) server/database.

FIG. 5 is a flow diagram of a method illustrating a caller initiated phone call, and an order completion for a service or a product as requested by the caller.

FIG. 6 is a flow diagram of a method illustrating scenarios of engaging a caller with a live agent.

FIG. 7 is a schematic diagram showing interactive tools or components utilized during rendering of the agent assisted browsing service.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematic and flow diagrams in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a method and system to provide an agent-assisted browsing service in terms of which a live agent assists a user of an endpoint device to perform a “browser-based activity”. The term “browser-based activity” is intended to mean any activity that can be performed through the use of a browser. Examples include search requests, online shopping, online banking, etc. In one embodiment, a user (further referred to as a caller, for ease of explanation), having need of a certain browser-based activity to be performed by a live agent, calls a number associated with an agent-assisted browsing service. The call is routed to an appropriate live agent who is trained to perform the browser activity on behalf of the caller. The live agent then interactively performs the browser-based activity on behalf of the caller. Advantageously, the caller does not have to perform the browser-based activity, thereby avoiding the problems associated with inputting and viewing information on mobile devices. Further, the interaction between the agent and the caller is a two-way or bi-directional interaction that occurs in real time. Information passed to the agent from an endpoint device is immediately viewable by the agent. Likewise, information passed to the caller by the agent is immediately viewable by the caller.

Also, the interaction between the agent and the caller may be twofold, comprising audible interaction e.g. in the form of a telephone conversation, and simultaneous graphical interaction, e.g. in the form of a synchronized display of browser-based information. By synchronized is meant that browser-based information viewable by the agent may simultaneously be viewable by the caller, in real-time.

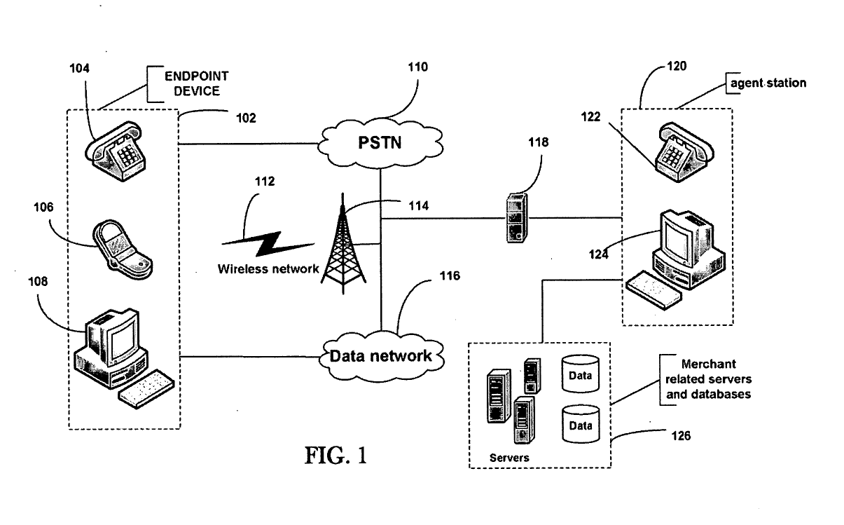

FIG. 1 shows a diagram of a network configuration for practicing embodiments of the invention. An endpoint device of a caller 102 communicates with an agent station 120 through an intermediate communications network. The endpoint device 102 may include a landline telephone 104, a mobile telephone 106, or a laptop or desktop personal computer (PC) 108. The intermediate communications network may comprise a PSTN network 110, a wireless network 112 (for example comprising one or more radio towers 114), and a data network 116 (e.g. the Internet). The communication network is linked to an Interactive Voice Response (IVR) server 118, which is linked to an agent station 120. The agent station 120 includes a voice communication device, e.g. an agent telephone 122 and an agent desktop computer 124. The agent station 120 is further linked to merchant related servers and databases 126, for example also via the communications network. The merchant related servers and databases 126 provide services or data comprising CRM data, inventory data, product data, web application server, IP SMS gateway server, financial data, and payment gateway server.

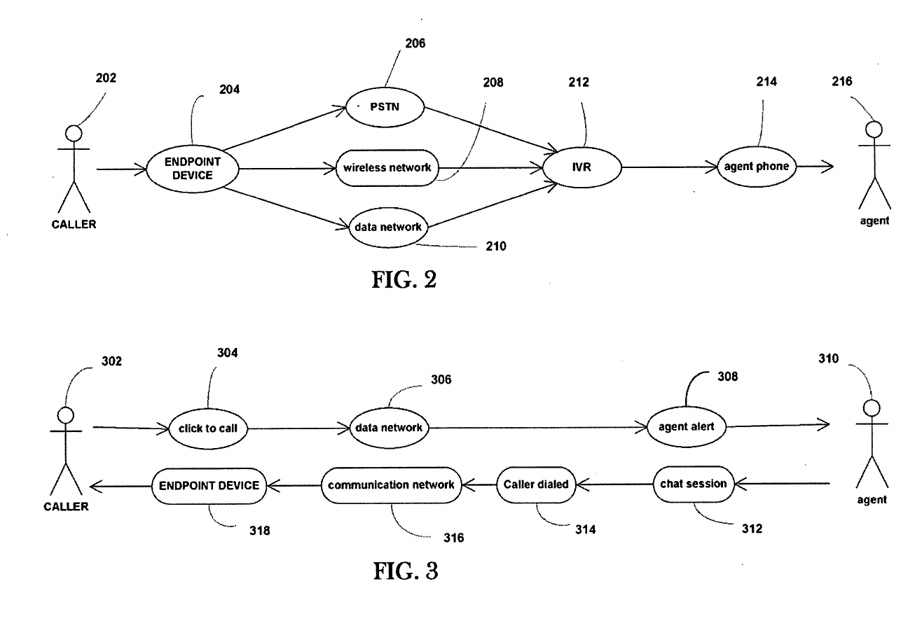

FIG. 2 is a schematic diagram of an embodiment showing routing of a telephone call originating from a caller 202. The caller 202 dials a number through an endpoint device, e.g. a caller telephone 204. The telephone call is transmitted by a network comprising a PSTN 206, a wireless network 208, or a data network 210. The telephone call is filtered through an IVR server 212, before being received by an agent phone 214 of a live agent (or an agent) 216.

Alternatively, in a different embodiment, as shown in FIG. 3, a caller 302 visits the web site of a merchant and clicks on a “click-to-call” feature 304, which causes a communication to be sent via a data network 306 to an agent 310, who, in turn, receives an alert 308. The agent 310 then initiates a chat session 312 by, for example, dialing a telephone number, at 314, associated with an endpoint device of the caller 302. The dialed telephone call is routed through the communications network 316 so that the caller 302 may answer the telephone call on the endpoint device, e.g. a caller telephone 318. Alternatively, the “click-to-call” feature, if selected from the endpoint device, may initiate a telephone call directly to the live agent 310. Instead, the chat session may be a text-based session.

The communication network 316 may vary greatly depending on the nature of the client communications. For example, in the case of internet protocol (IP) based telephone calls, the communications network may include the Internet, while in the case of caller communications comprising an endpoint device in the form of a land-line telephone 104, the communications network may be a public switched telephone network (PSTN) 110, or even a mobile telephone Network (MTN) that comprises the radio tower 114 and wireless network 112 equipped to transmit telephone messages/communications wirelessly.

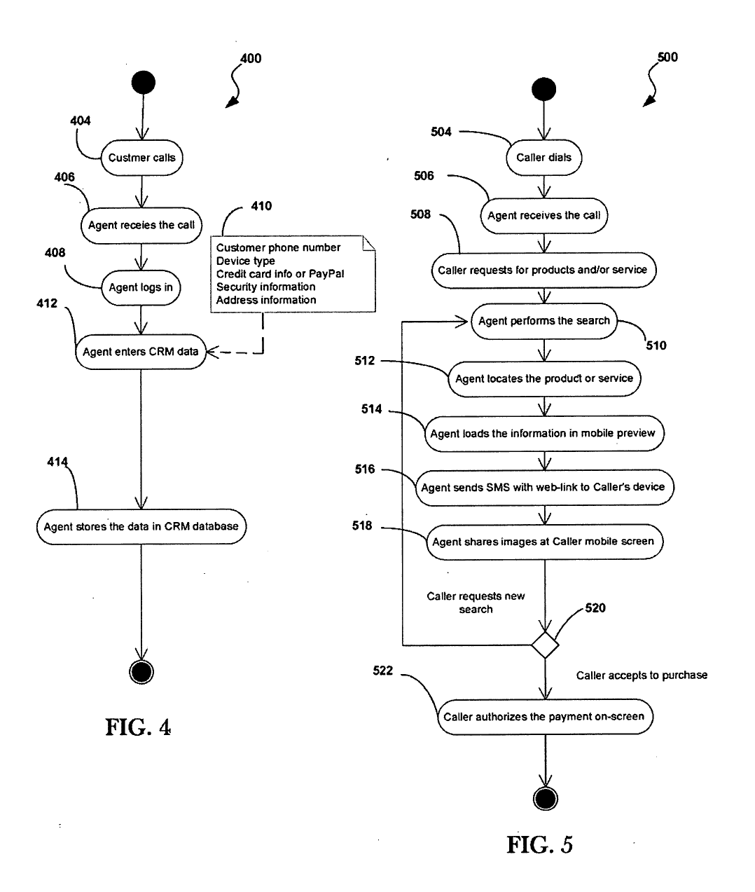

FIG. 4 is a flow diagram of a method 400, illustrating initial registration of a caller. The initial registration may be necessitated when high security standards are needed, for example, when using credit card information, or when arranging for shipment. The initial registration may not be necessitated when a caller calls only for information purposes. To ensure that a correct caller has been registered, the initial registration may be confirmed by sending an email or a SMS message or by concluding a telephone call.

When a caller calls, at 404, a live agent at the agent station receives the call, at 406, via the agent telephone 122. At 408, the agent logs into the agent desktop computer 124. It is to be understood that the agent may already be logged in, in which case, step 408 may have been completed prior to the caller calling, at 404. While maintaining the phone call, the agent enters CRM information 410, at 412, which he may receive during the telephone conversation from the caller. At 414, the CRM information 410 is saved in the CRM database. The CRM information 410 may comprise the caller's telephone number, a type (e.g. make and model) of the endpoint device of the caller, financial information (e.g. credit card/PayPal™ information), security information (e.g. mother's maiden name), and shipping address information. The CRM information 410 may include other information relevant to business. The CRM information entry may be carried out at any time that is convenient for the caller. After the initial registration, the CRM information 410 is maintained in the CRM server that is hosted by the merchant related servers and databases 126. The subsequent edit of CRM information 410 may be performed at any time. The caller may be uniquely identified utilizing a variety of identifiers (discussed below). After the initial registration is completed, the caller may be given a designated telephone number to call. By calling the telephone number, the telephone call may be routed to an appropriate live agent based on a type of product or service requested. The caller may also click on “click-to-call” on a web site of the merchant, from where the telephone call can be routed to an appropriate live agent. There may be an option on the merchant's web site to use a chat session. The chat session may be followed up by a telephone call initiated from the agent, if the caller so requires. In one embodiment, the caller may be provided with a web screen on his endpoint device, the web screen containing relevant information to initiate a telephone call to the live agent. The customer may, if so desired, install a dedicated mobile application to enable display of the web screen by the endpoint device. Alternatively, the agent may direct the caller to a web-site, listing available agents, and suggest that the caller click on the agent's name (as an example of agent selection by some form of ID), thus establishing a web-link between the agent and the caller.

FIG. 5 is a flow chart of a method 500 which illustrates an interaction between a caller and a live agent. At 504, the caller initiates a telephone call, e.g. by dialing a telephone number, to the agent. At 506, the agent receives the telephone call. The agent then composes a message, in the form of an SMS message, which includes a web-link, e.g. a URL, accessible by the endpoint device of the caller. The agent sends, at 508, the SMS message to the endpoint device. An IP (Internet Protocol) SMS gateway server may be utilized to send SMS messages in bulk. In an alternative, the agent may simply speak the web-link to the caller in response to which the caller would manually enter the web-link in the endpoint device.

Upon receipt of the SMS message, the caller selects and follows, at 509, the web-link. A mobile web-browser displays on the endpoint device a web page to which the link points. The web page displayed by the endpoint device is linked or synchronized with a mobile preview section provided by a display of the agent desktop computer 124. In other words, editing of the mobile preview section by the agent effects a corresponding change in the web page viewed by the caller. Thus, information in the mobile preview section can be viewed simultaneously by the agent and the caller. Conversely, editing by the caller (e.g. selection of one of a plurality of options in a list) of the web page is shown in the mobile preview section and is viewable by the agent. Thus, the web-page provides for two-way, interactive communication.

At 510, the caller requests, by speaking, particular products and/or services. If desired, after 509, the registration of customer data, as illustrated in FIG. 4 by the method 400, may be performed. At 510, the agent receives a spoken request or an order for the products and/or the services, and, at 512, the agent performs a search (which may, for example, be an Internet search or an Intranet database search). At 514, the agent locates potentially relevant and/products or services (further referred to as search results). At 516, the agent graphically composes the search results in the mobile preview section of the display of the agent desktop computer 124. Thus, by composing the search results in the mobile preview section, the agent configures display of information relevant to what the caller said during the voice call for display on the endpoint device of the caller. In other words, the information (e.g. the search results) may be configured specifically for display on the endpoint device of the caller, taking into account, for example, a display size and resolution of the endpoint device. The mobile preview section is automatically synchronized, at 518, with the endpoint device. Thus, as the mobile preview section is updated, so too is the information displayed on the endpoint device, the endpoint device having a “live” connection to the mobile preview section. In other words, the mobile preview section is actually displayed on the display of the endpoint device, in real-time. This allows the caller to see a display of the search results on the endpoint device. At 520, an on-screen selection of the products or the services from the search results may be made or selected by the caller. The caller may select a product or service by speaking his selection to the agent or by indicating his selection on the web page. However, if the caller is not satisfied with the search results from the live agent, the method 500 may be repeated from 510. At 522, the caller is presented with on-screen payment options from which payment may be authorized.

In this fashion, a caller can reap the benefits of viewing information, i.e. search results, in a browser-based format, but without having to perform the actual browsing from the endpoint device. Instead, the browsing is done by the agent based upon the telephonic directions given by the caller.

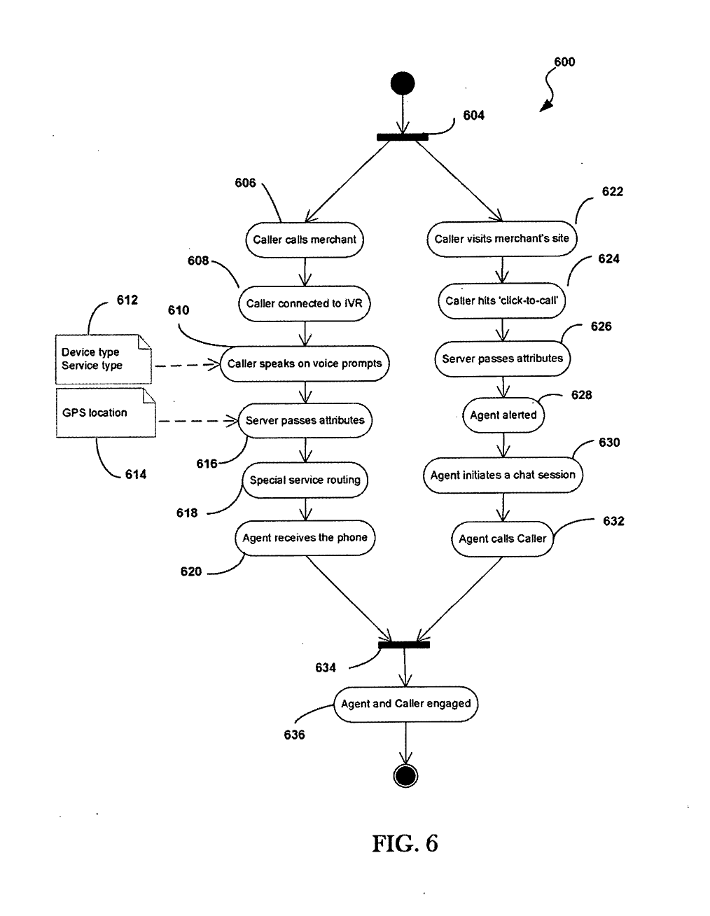

Referring now to FIG. 6, a method 600 is illustrated and describes two ways of engaging a live agent by a caller in a telephone conversation. The method branches, at 604, depending on how the caller wishes to initiate the telephone conversation. A first option for initiating the conversation, at 606, requires the caller to call the merchant directly using the endpoint device. At 608, the call is connected to the merchant's IVR server. At 610, the caller interacts with IVR server's voice prompts, and enters information 612, including an identification 612 of the endpoint device (if not already entered). In this fashion, the merchant related servers 126 (or, alternatively, the agent station 120) identify the endpoint device (for example, an Apple iPhone), so that the mobile preview section may be configured specifically for the particular endpoint device. Also, information 614 relating to GPS location of the caller, or service type, for example an order of flowers, may be inputted to the IVR server at 610 by way of the caller's voice tag. The IVR server processes the attributes by utilizing the inputs from the voice tags. At 616, the IVR server passes the call and the attributes of the caller to an appropriate telephone router. At 618, the telephone router routes the call to an appropriate live agent. At 620, the live agent receives, and answers, the call. At 636, both parties are engaged in talking. At 634, the live agent can send a message to the caller to effect display of the information on the endpoint device, as described in the method 500 of FIG. 5. The attributes of the caller or the information of the caller may be uniquely identified by unique identifiers as described in this paragraph below.

Instead, at 622, the caller may choose to visit the merchant's web site. At 624, the caller clicks on a “click-to-call” button or link on the web site. At 626, the server processes attributes of the caller by using the unique identifiers and/or CRM information 410. At 628, the live agent is alerted to the caller's activity via the agent desktop computer. Selection of the “click-to-call” button may result automatically in the display on the endpoint device of information in the mobile preview section. Thus, the order in which the telephone call is connected and the web-link is selected is not essential. At 630, the information displayed in the mobile preview section is displayed simultaneously on the caller's endpoint device, and vice versa. Thus, the web page provides a two-way interactive web channel which may include videos, images, or any other media which can be displayed on conventional web pages.

The agent initiates a telephone call at 632 and both parties engage, at 636, in a conversation.

The IVR server is a choice out of many alternatives to identify the caller, and so is the GPS location data 614 for locating the caller. It is known to a person of ordinary skill in the art that a caller making a call may be uniquely identified utilizing a variety of identifiers such as Automatic Number Identification (ANI), a customer ID, an email address, an IP address, a web address uniform resource locator (URL), a dialed number identification service (DNIS), form data, interactive voice response (IVR) data, speech recognition data, etc. Thus, identification of the endpoint device of the caller could be done automatically, for example using one or more of the identifiers and optionally also by interrogating a pre-populated database including an identifier associated with information about the endpoint device.

The agent desktop computer is linked using a network interface with the merchant related servers and databases 126 which comprise the application server, the web server, the CRM database, the product database, the IP SMS gateway server, and the payment processing gateway server. The agent will retrieve the information, as required, by using the merchant related servers and databases 126, and by using a variety of identifiers such as Automatic Number Identification (ANI), customer ID, email address, IP address, web address uniform resource locator (URL), dialed number identification service (DNIS), form data, interactive voice response (IVR) data, speech recognition data, etc.

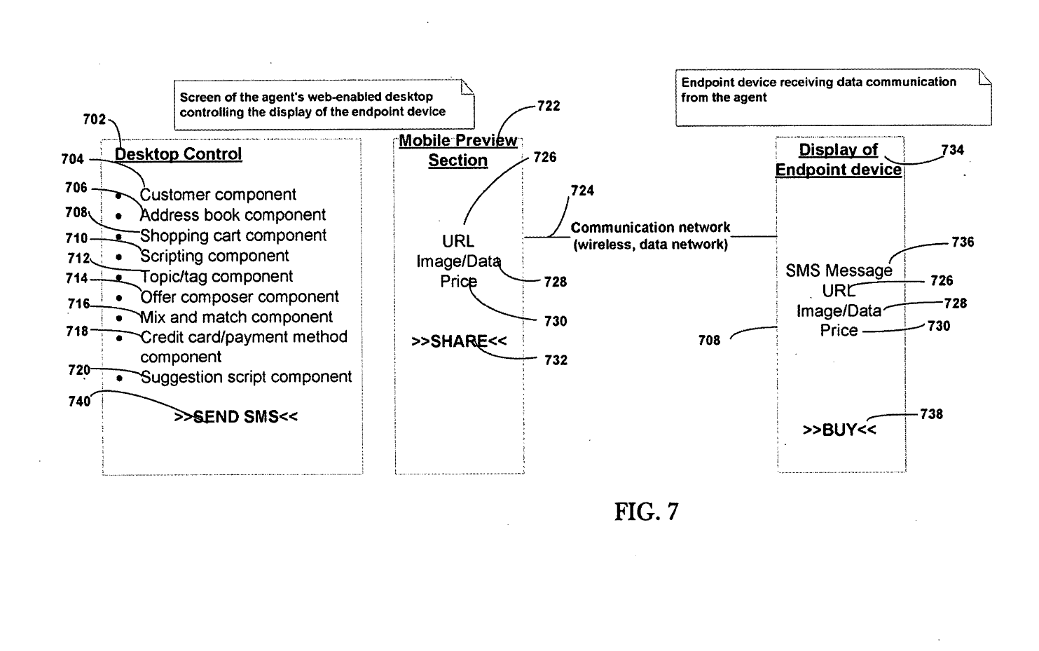

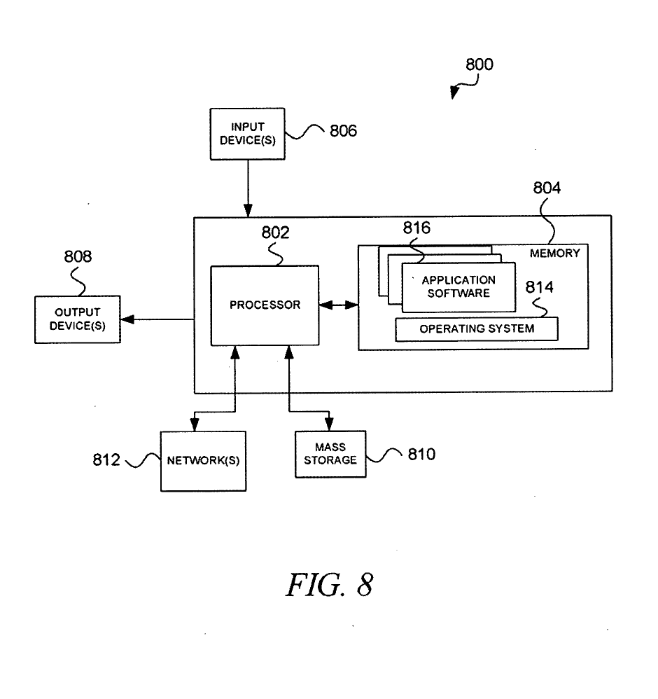

FIG. 7 shows a schematic diagram showing interactive tools or components utilized during rendering of an agent assisted browsing service in an example embodiment. The tools or components illustrated in FIG. 7 may be provided by a system for agent-assisted browsing (e.g. including the agent desktop computer 124) in accordance with an example embodiment. Some of the components shown in FIG. 7 may be displayed or initiated after the agent and the caller are engaged in a conversation. The agent desktop computer 124 has a display which is divided into two parts, namely a desktop control 702, and a mobile preview section 722. The desktop control 702 has components that are necessary or useful to process a caller order, to complete a business transaction and to perform browsing on behalf of the caller. These components include, but are not limited to, a customer component 704, an address book component 706, a shopping cart component 708, a scripting component 710, a topic/tag component 712, an offer composer component 714, a mix and match component 716, a credit card/payment method component 718, and a suggestion script component 720.

The set of components at desktop control 702 are further described below:
Caller component 704—a display of caller's data such as name, address, previous orders, etc.
Address book component 706—an address book for a caller.
Shopping Cart component 708—a display/invoice of what a caller is ordering.
Scripting component 710—a script informing an agent of what to say.
Topic/Tag component 712—a component which allows an agent to search and select, using a search bar, a set of products based on tags (e.g. “roses,” “red,” or “red roses”, etc.), or sets of tags (e.g. “Valentine's day,” “Mother's day,” etc.)
Offer composer component 714—a display of selected products in visual (thumbnails) and/or textual form.
Mix and match component 716—additional components that third-party companies or merchants, who want to sell their products through the present inventive concept(s), may use, such additional components may include third-party components that could be integrated and may be lightweight and atomic.
Credit card/payment method component 718—information regarding finances, for example: credit cards: Visa™, MasterCard™, American express™, Discover™; PayPal™ or third party payment processing information; bank information, checking account and routing number.
Suggestion script component 720—information comprising: a guide to an agent to construct verbiage while presenting and offering the searched product or service to a customer; a way of presenting a product in a professional manner; a way to make suggestions to a customer regarding product selection; and/or any matter that is considered relevant to ensure customer satisfaction, for example: an instruction to give a customer something that he or she will not soon forget, e.g. a beautiful flower bouquet from the heart.
Mobile preview section 722—a display of a graphically composed mobile preview which is relevant to a caller and which is shared to the endpoint device and which is configured to match or emulate a display of the endpoint device.

One of ordinary skill in the art would know that the agent may utilize any or all of the components—704, 706, 708, 710, 712, 714, 716, 718 and 720—based on business needs and types of callers dealt with, events, promotions, sales goals, and industry best practices.

Shortly after the caller and the agent engage in a telephone conversation, the agent composes a message at the agent desktop computer 124. The message may be an SMS message that contains a web link or a URL link 726, pointing to the mobile preview section 722. Thus, selection of the URL link 726 synchronizes the display 734 of the endpoint device and the mobile preview section 722. Updates made by the agent to the information in the mobile preview section 722 are also shown in the display 734 of the endpoint device and, correspondingly, updates made by the caller to the display 734 of the endpoint device are also shown in the mobile preview section 722. The SMS message is sent by using a ‘Send SMS’ soft button 740.

The caller then requests or orders specific products or services. The agent searches the Internet, and locates the products or the services. Thereafter, the agent loads the findings in the desktop control 702, and utilizes any or all of components 704, 706, 708, 710, 712, 714, 716, 718 and 720, as the agent may view necessary. The agent further composes the mobile preview section 722 on the display of the agent desktop computer. The mobile preview section 722 is a presentation section that is used to compose a mobile preview using graphical images of findings from search results with relevant information, for example, the price of and images of related products or services. The mobile preview section 722 may be updated automatically to synchronize with the display 734 of the endpoint device. Instead, there may be provided a soft button ‘Share’ 732 to cause synchronization of the mobile preview section 722 with the display 734 of the endpoint device. In such case, the agent may compose the mobile preview section 722 and upon completion thereof, allow synchronization by pressing “Share” 732. However, a person of ordinary skill in the art may not necessarily use or design the exact soft-keys ‘Share’ 732 or ‘Send SMS’ 740. Alternative words or alternative steps, for example, command-based functions or drop-down menus from a toolbar, could be used to achieve the desired functionalities. The mobile preview section 722 contains the URL 726 and the image/data 728 along with the price information 730. The communication network 724 connects data and voice communication between the agent and the caller.

The caller may use the soft button ‘Buy’ 738 to make the purchase, and it is followed by authorization of payment by the caller utilizing information contained in the credit card/payment method component 718.

Information that may be relevant during composing the mobile preview section 722 may include, but is not necessarily limited to, a name of the products or services, a description, price information, a thumbnail image URL, large image URL, tags, and inventory control. It is known to a person of ordinary skill in the art that the creation of a product database, which is a part of the merchant related servers and databases 126, can be via a variety of techniques. Alternatively, a web-service can be created that interrogates and updates the product database as needed; options to change, add, and delete may be supported as well. For screen and image capture, a utility to capture part of a web page may consist of a URL encoded as a bookmark browser button that has an embedded JavaScript function call which returns the selection for further parsing into an image URL and possible description. Since the product's image URL will need to be downloaded onto the endpoint device, some image compression may be advantageous. The ImageMagick® library or other image libraries, as appreciated by a person of ordinary skill in the art, may be used to compress both jpeg and gif images, and to see which one is smaller, saving the result on file system as a static URL. Each product has attached thereto a set of tags (for example, roses, red, red roses, Valentines Day, etc.). These tags allow the agent to search for a group of products satisfying conditions as requested by the caller. The price range may itself be a tag. The search bar in the topic/tag component 712 may auto complete from the set of available tags. Tags can be grouped, for example Valentine's Day can be a short hand for “roses,” and “red.” To extract the tags automatically from product descriptions and names, ‘part-of-speech tagging’ or ‘grammatical tagging’ techniques may be employed. Alternatively, a method of extracting nouns and adjectives, culling by a certain frequency count, and allowing the seller to edit tags via product uploader or editor interface, may be used. The mobile preview section 722 formats resulting products for interactive presentation and also respects the appropriate stylistic conventions of the intended endpoint device, for example, lists for Apple's iPhone, and tables for web browser.

The schematic diagram and flow charts as shown in the figures may be practiced in any appropriate combination or order, as viewed necessary by a person of ordinary skill in the art. Alternative embodiments may be used in any combination or order, as appreciated by a person of ordinary skill in the art, to be able to make and use the inventive concept without departing from the broader spirit of the invention.

The present invention may be better explained through a practical example involving the agent-assisted browsing. The example, as explained below, is only for illustrative purposes so that a better understanding of the invention may be achieved.

In the example, it is assumed that the caller “Alice” calls the company from a conventional telephone number such as, 1-800-Flowers, and the call reaches the agent or customer service representative (CSR) “Bob”. Alice has already performed the initial registration, as shown by the method 400 in FIG. 4, by calling the merchant at the company number. Therefore her information regarding CRM data, financial information (credit card number), security-related information, residential address, and her previous transaction history is stored in the merchant related servers and databases 126.

The network environment is set out as shown in FIG. 1. Alice calls the number, 1-800-Flowers, at 504 or at 606, using an Apple iPhone, which is an example of an endpoint device 106. The Apple iPhone uses the communications network including the radio tower 114 and the wireless network 112. Alice is routed into the IVR server (tree) 212, which at some point prompts for an indication of the endpoint device, e.g. “Do you have an iPhone?” Alice responds “Yes,” at 610, during which the IVR server 212 processes the attributes at 616, and the call is routed as appropriate, at 618. At 620, an Apple iPhone sale CSR picks up the phone.

At 636, Bob says, “Welcome to 1-800-Flowers. How can I help you today?” Alice replies, “I'd like to order some flowers for my mother,” at 508. Bob says, “Great, I'm sending you a SMS message, please click on the link (URL 726) when you receive it,” at 516. A moment later, Alice receives the SMS message 736, opens it up and clicks on the URL link 726.

Alice's web browser opens up on the iPhone, and she receives a “Welcome to 1-800-Flowers, Alice.” The browser sends a message to Bob indicating that the page has been viewed. Bob says, “What kind of flowers would you like?” Alice says, “Some cut flowers in a vase, under $50,” at 508. Bob says “Wonderful, let me see what choices are available.” At 510, Bob searches the Internet or the database 126 to find cut flowers. At 512, Bob locates search results in the form of applicable cut flowers. At 514, Bob loads some dahlias, chrysanthemums, etc., into his preview pane or mobile preview section 722. After the mobile preview is ready for Alice to view, Bob pushes the send button or ‘Share’ soft button 732. He then says, “I'm sending you some choices to your iPhone. When you see a choice you like, just touch it.” Alice's browser updates or refreshes. The mobile preview section 722 is configured specifically to match or emulate the display of the endpoint device of the caller. Thus, the mobile preview section 722 emulates the display of an iPhone, for instance having the same dimensions and resolution as the display of the iPhone, so that the page (to which the URL points) is displayed without distortion. Furthermore, Bob can see in his mobile preview section 722 exactly what Alice sees on her iPhone display, thus enabling Bob to ensure that the page is easily readable and assist Alice in navigating the page, where necessary.

Alice then selects, at 520, the purple chrysanthemums and the iPhone browser notifies Bob of the choice. Bob sends Alice her address book 706 used for previous flower purchases—the previous transaction stored on the merchant servers and databases 126, and tells her to select her mother's address where she wants the cut flowers to be delivered. Bob says “Great!” and asks if there is anything else Alice would like today. Alice says, “No,” and Bob says, “I'm sending you the order confirmation, please press the ‘purchase’ button and the flowers are on their way.” Alternatively, the soft button “Buy” 738 may be functionally identical to the “purchase” button. In one embodiment, selection of the “purchase” button causes the end point device to transmit a payment token to a merchant server. The payment token contains payment information such as credit card information. The payment is encrypted for security purposes. The merchant server decrypts the payment token and processes payment. Advantageoulsy, Alice's credit card information is not seen by Bob, thereby enhancing the security of the transaction. Alice touches the “purchase” soft button (or ‘Buy’ soft button 738) at the bottom of the invoice, and a message is sent to Bob. Bob tries to up sell Alice with some more cut flowers. She says, “No thanks.” Bob says, “The flowers are on their way to 456 Wildemo Way in WoughWii, Illinois,” and sends Alice a thank you page. Bob tells Alice, “Please push the button on the wrap up page, if you would, to help us improve our service.”

One of ordinary skill in the art knows that the activities and the schematic and flow diagrams may be performed in other orders or combinations, but the inventive concept of the agent assisted browsing remains without departing from the broader spirit of the invention. Every caller may be unique, and activities or method steps may be either shortened or lengthened, overlapped with the other activities, postponed, delayed, and continued after a time gap, such that every caller is accommodated for the agent assisted browsing service.

The present invention may be implemented in hardware or in software. FIG. 8 of the drawings shows an example of a system 800. Many components of the system 800, in accordance with an example embodiment, for example, network interfaces etc., have not been shown, so as not to obscure the present invention. However, one of ordinary skill in the art would appreciate that the system 800 may include these components. More particularly, the system 800 may be in the form of the agent desktop computer 124.

The system 800 typically includes at least one processor 802 coupled to a memory 804. The processor 802 may represent one or more processors (e.g., microprocessors), and the memory 804 may represent random access memory (RAM) devices comprising a main storage of the system 800, as well as any supplemental levels of memory e.g., cache memories, non-volatile or back-up memories (e.g. programmable or flash memories), read-only memories, etc. In addition, the memory 804 may be considered to include memory storage physically located elsewhere in the system 800, e.g. any cache memory in the processor 802 as well as any storage capacity used as a virtual memory, e.g., as stored on a mass storage device 810.

The system 800 also typically receives a number of inputs and outputs for communicating information externally. For interface with a user or operator, the system 800 may include one or more user input devices 806 (e.g., a keyboard, a mouse, imaging device, etc.) and one or more output devices 808 (e.g., a Liquid Crystal Display (LCD) panel, a sound playback device (speaker, etc)).

For additional storage, the system 800 may also include one or more mass storage devices 810, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 800 may include an interface with one or more networks 812 (e.g., a local area network (LAN), a wide area network (WAN), a wireless network, and/or the Internet among others) to permit the communication of information with other computers coupled to the networks. It should be appreciated that the system 800 typically includes suitable analog and/or digital interfaces between the processor 802 and each of the components 804, 806, 808, and 812 as is well known in the art.

The system 800 operates under the control of an operating system 814, and executes various computer software applications, components, programs, objects, modules, etc. to implement the techniques described above. Moreover, various applications, components, programs, objects, etc., collectively indicated by reference 816 in FIG. 8, may also execute on one or more processors in another computer coupled to the system 800 via a network 812, e.g. in a distributed computing environment, whereby the processing required to implement the functions of a computer program may be allocated to multiple computers over a network. The application software 816 may include a set of instructions which, when executed by the processor 802, causes the system 800 to perform the method 400, 500 or 600.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

What is claimed is:

1. A method, comprising:
providing to a live agent, a desktop control with relevant tools to facilitate an interaction with a caller;
maintaining a voice call via a telecommunications network between said live agent and said caller;
identifying an endpoint device of the caller; and
displaying synchronized information relevant to what the caller said during the voice call simultaneously on the desktop control and the endpoint device, the information being configured for display on the endpoint device.

2. The method of claim 1, wherein said endpoint device is a browser enabled wireless phone.

3. The method of claim 1, wherein said telecommunications network is a wireless network.

4. The method of claim 1, wherein said relevant tools in said desktop control are selected from a group composed of a customer component, an address book component, a shopping cart component, a scripting component, a topic/tag component, an offer composer component, a mix and match component, and a credit card/payment method component.

5. The method of claim 1, wherein the voice call is initiated by the caller, the method further comprising sending a link to the endpoint device of the caller, selection of the link causing display of the information.

6. The method of claim 5, wherein said link is sent via an SMS (Short Message Service) message.

7. The method of claim 5, wherein said link is a browser executable web link.

8. The method of claim 1, further comprising providing a “click-to-call” link on a webpage, said “click-to-call” link, when selected, initiating display of the information.

9. The method of claim 8, wherein the voice call is initiated by the live agent in response to selection by the caller of the “click-to-call” link.

10. The method of claim 1, wherein the information relevant to what the caller said during the voice call is selected from a relevant group of servers and databases composed of an IVR (Interactive Voice Response) server, a CRM database, an inventory database, a product database, a payment gateway server, and a PayPal™ server.

11. The method of claim 1, further comprising retrieving data including credit card information which is not accessible by said live agent.

12. A computer-readable medium having stored thereon a sequence of instructions, which when executed by a computer, cause said computer to perform a method, the method comprising:
retrieving by the computer relevant information to a live agent in a display while maintaining a voice call between a live agent and a caller;
identifying an endpoint device of the caller;
displaying synchronized information relevant to what the caller said during the voice call simultaneously on the desktop control and the endpoint device, the information being configured for display on the endpoint device.

13. The computer-readable medium of claim 12, wherein said computer is a web-enabled desktop control that comprises a customer component, an address book component, a shopping cart component, a scripting component, a topic/tag component, an offer composer component, a mix and match component, and a credit card/payment method component.

14. The computer-readable medium of claim 12, wherein said endpoint device is a browser enabled wireless phone.

15. The computer-readable medium of claim 12, wherein the voice call is initiated by the caller, the method further comprising sending a link to the endpoint device of the caller, selection of the link causing display of the information.

16. The computer-readable medium of claim 11, wherein said link is sent to said endpoint device via a message and said link is a browser executable web link relevant to said caller.

17. The computer-readable medium of claim 11, wherein the method further comprises providing a “click-to-call” link on a webpage, said “click-to-call” link, when selected, initiating display of the information.

18. The computer-readable medium of claim 17, wherein the voice call is initiated by the live agent in response to selection of the “click-to-call” link.

19. A system for agent-assisted browsing, the system comprising:
a desktop control with relevant tools to facilitate an interaction by an agent with a caller; and
a voice communication device for maintaining a voice call via a telecommunications network between said live agent and said caller;
the desktop control being operable to cause display of synchronized information relevant to what the caller said during the voice call simultaneously on the desktop control and the endpoint device, the information being configured for display on the endpoint device.

20. The system of claim 19, wherein the tools in said desktop control are selected from a group comprising a customer component, an address book component, a shopping cart component, a scripting component, a topic/tag component, an offer composer component, a mix and match component, and a credit card/payment method component.
